(19) United States
(12) Patent Application Publication
(10) Pub. No.: US 2024/0173769 A1
(43) Pub. Date: May 30, 2024

(54) DYNAMIC IN-FLIGHT CHARACTERIZATION OF BUILD MATERIAL IN A 3D PRINTER AND SYSTEM AND METHODS THEREOF

(71) Applicant: XEROX CORPORATION, Norwalk, CT (US)

(72) Inventors: Douglas K. HERRMANN, Webster, NY (US); Jason M. LeFEVRE, Penfield, NY (US); Seemit PRAHARAJ, Webster, NY (US); Varun SAMBHY, Pittsford, NY (US)

(73) Assignee: XEROX CORPORATION, NORWALK, CT (US)

(21) Appl. No.: 18/059,638

(22) Filed: Nov. 29, 2022

(51) Int. Cl. B22D 23/00; B22D 46/00; B33Y 10/00; B33Y 30/00; B33Y 50/02

(52) U.S. Cl. CPC B22D 23/003; B22D 46/00; B33Y 10/00; B33Y 30/00; B33Y 50/02

(57) ABSTRACT

A system and method of characterizing drops of printing material in a 3D printer is disclosed, which includes ejecting a drop from a nozzle of an ejector in the 3D printer, intersecting the drop with a beam while the drop is in-flight, and determining one or more physical characteristics of the drop. The system and method may include where the drop intersects the beam between the nozzle and a substrate of the 3D printer or the drop intersects the beam between the nozzle and a top surface of a part printed by the 3D printer. The beam is located between an emitter and a detector are each positioned external to one or more side walls of a 3D printer. A physical characteristic of the drop may include drop size, drop shape, or drop mass and comparison with a reference.

### TECHNICAL FIELD

The present teachings relate generally to liquid ejectors in drop-on-demand (DOD) printing and, more particularly, to methods and apparatus for characterizing in-flight build material of a drop-on-demand liquid ejector for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, 3D printing technology is well known for enabling the manufacture of complex 3D designs which otherwise could not be made using traditional methods such as machining, casting, or injection molding. This ability is made possible through a common trait that all the 3D printing processes share, which is to divide a given geometry along the printing direction into multiple two-dimensional (2D) layers and print one layer at a time. In this approach, it can deposit the molten droplets on a heated build plate or substrate precisely using computer numerical control. In such a process, it is important to ensure the drop integrity, with respect to drop size and drop shape, as both affect the integrity of the build part. In order to properly fuse the molten print material, the molten drops need to be of a controlled temperature, and the drops need to be of the correct and consistent size and shape to maintain the functional integrity of the part. Current printing systems do not have a means to monitor or measure the drop characteristics, such as, but not limited to drop size and drop shape. Limited information related to the molten drops is known during printing, which can lead to inconsistencies within the build part. During printing, buildup of dross or other contaminants around the nozzle can lead to sputtering. This sputtering can cause drop contamination, also causing reduced drop quality. This reduction in drop quality compromises the part integrity, resulting in subsequent builds with having suspect part integrity. Any build quality issues due to drop size issues or sputtering is currently not detected during the build or print process. If a drop issue or build issue goes undetected, a multi-hour build may continue until completion even if the final part will be unacceptable.

Therefore, it is desirable for a method or apparatus capable of measuring or analyzing molten drops of print material after ejection and prior to landing onto a substrate or build surface.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of characterizing drops of printing material in a 3D printer is disclosed, which includes ejecting a drop from a nozzle of an ejector in the 3D printer, intersecting the drop with a beam while the drop is in-flight, and determining one or more physical characteristics of the drop. Implementations of the method of characterizing drops of printing material in a 3D printer may include where the drop intersects the beam between the nozzle and a substrate of the 3D printer. The drop intersects the beam between the nozzle and a top surface of a part printed by the 3D printer. The beam is in a horizontal orientation. The beam is located between an emitter and a detector are each positioned external to one or more side walls of a 3D printer. A physical characteristic of the drop may include drop size. A physical characteristic of the drop may include drop shape. A physical characteristic of the drop may include drop mass. The method of characterizing drops of printing material in a 3D printer may include comparing the one or more physical characteristics of the drop with a reference. The method of characterizing drops of printing material in a 3D printer may include determining a defect by comparing one or more physical characteristics of the drop with a reference or pausing one or more printing operations. The method of characterizing drops of printing material in a 3D printer may include correcting a defect in a drop ejected by the 3D printer. The print material may include aluminum.

Another method of characterizing drops of printing material in a 3D printer is disclosed, which includes intersecting a collimated laser beam from an emitter with a drop of printing material, detecting the drop of printing material with a detector, and analyzing one or more physical characteristics of the drop of printing material. Implementations of the method of characterizing drops of printing material in a 3D printer may include where a physical characteristic of the drop can include drop size, drop shape, drop mass, or a combination thereof. The drop of printing material intersects the collimated laser beam while the drop is in-flight. The method of characterizing drops of printing material in a 3D printer may include comparing the one or more physical characteristics of the drop with a reference. The method of characterizing drops of printing material in a 3D printer may include determining a defect by comparing one or more physical characteristics of the drop with a reference.

A printing system is disclosed, which includes a substrate, an ejector for jetting a liquid print material onto the substrate. The printing system also includes a 2-dimensional beam sensor, where a beam emitted by the 2-dimensional beam sensor measures a drop of the liquid printing material when the drop is between the ejector and the substrate. Implementations of the printing system may include where the beam emitted by the 2-dimensional beam sensor measures the drop of the liquid printing material when the drop is between the ejector and a surface of a part being printed by the printing system. The liquid print material may include a metal, a metallic alloy, or a combination thereof. The liquid print material may include aluminum. The ejector further may include a structure defining an inner cavity, and a nozzle orifice in connection with the inner cavity and configured to eject one or more drops of liquid print material. The printing system may include an inner chamber located below the ejector and above the substrate, and an outer chamber area may include an emitter and a detector of the 2-dimensional beam sensor. The inner chamber permits no light to enter or escape. The printing system may include at least one aperture through which the beam passes. The printing system may include a door configured to intermittently cover the at least one or more aperture. Implementations of the described techniques may include hardware, a method or process, or computer software on a computer-accessible medium.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIG. 2 depicts an enlarged side view of a bottom portion of an ejector nozzle of a 3D printer, in accordance with the present disclosure.

FIGS. 3A-3C depict several views of a 3D printer system having an in-flight characterization system, in accordance with the present disclosure.

FIG. 4 is a flowchart illustrating a method of characterizing drops of printing material in a 3D printer, in accordance with the present disclosure.

FIG. 5 is a flowchart illustrating a method of characterizing drops of printing material in a 3D printer, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary examples of the present teachings, examples of which are illustrated in the accompanying drawings. Wherever possible, the same reference numbers will be used throughout the drawings to refer to the same, similar, or like parts.

As defined herein, a “reference” drop of print material may be defined as an ideal drop of print material, as described in terms of its dimensions, density, composition, shape, ejection speed, or other characteristics or parameters determined by a standard setup of a printing system or part of a printing system, such as an ejector or nozzle. It should be noted that the parameters or characteristics of a reference drop may be different from one printing system to another printing system or within a single printing system, as defined by a setup or other operating condition of the printing system, or from one print or build material to another print or build material. For example, in certain examples of 3D printing systems, a spherical drop of print material of a nominal 500 μm size may be a sufficient reference, with deviations from such a reference potentially indicative of issues such as contamination in the ejector or around a nozzle. Non-standard drops may be elongated, include satellite or smaller drops broken off from an intended drop, and the like.

By monitoring and analyzing the drop characteristics in flight prior to impacting a part or a substrate, the shape and size of the drops or other parameters can be confirmed. If any issues are noted, the system can be paused while the system parameters are confirmed, altered and/or the nozzle condition is inspected for issues and subsequently addressed to improve the build quality. The drop is analyzed to ensure the nozzle and system are working within the specified operating parameters. This drop monitoring and characterization can allow for optimized bonding between the molten drop and the build surface, as one example. This monitoring and characterization can be done during a printing operation rather than waiting to do an inspection after the build, when changes in the build parameters or quality are no longer possible. The in-flight characterization system monitors the drop parameters during build and the system can be paused when an issue is detected. This allows an operator to address the issue during the build by stopping the build of a part that would fail in a final inspection or use.

The present disclosure provides an in-flight characterization system includes a 2-dimensional (2D) beam sensor that measures a drop of build material or print material across the flight trajectory between the nozzle and the build part or substrate. As the drop transits through the beam it is detected, and its size and shape can be measured. If the size, shape, or other factor of a drop falls outside of the set parameters (i.e., diameter <500 μm) a signal can be sent to alert the system that the system is not operating at optimal levels. At such a point, the system is paused to allow an operator to evaluate the system. If, for example, build up around the nozzle is observed, the nozzle can be cleaned or replaced, and the build process is started again with the sensing restarting to continuously monitor the drops. The system continuously measures each drop, or in some examples, optionally can be used to statistically sample drops within a part build.

Certain examples of 3D printing systems as described herein can include a heated, enclosed, and insulated box around the build volume to maintain higher build temperatures within the build volume. This enclosure, or chamber, in certain examples, can be a transparent enclosure. The sensing systems can reside outside of this build volume and the enclosure. Certain examples of an in-flight characterization system can include an emitter and a collector portion of the sensing system that transit the outer insulated area via a 2-dimensional slit or aperture on one, both, or either side. This slit or aperture may include an activated cover or optional air curtain. In certain examples, the inner chamber permits no light to enter or escape. For the purposes of this disclosure, light can be considered include radiation in the ultraviolet, visible, infrared, or combination thereof.

A light-emitting diode (LED) system is depicted herein that detects and characterizes drops in flight. In certain examples, the sensing and characterizing of a molten aluminum drop occurs at a cycle rate of 16 kHz and a accuracy of 2 μm. Sensing can be accomplished with the use of either a 2D laser, LED sensing, or other methods. In examples of the present disclosure, the use of a laser or Complementary metal-oxide-semiconductor (CMOS) light emitting diode (LED) laser provides a measurement that can be used on a gap of approximately 5 mm, which can range from about 2 mm to about 40 mm in some examples, between an ejector nozzle and a build part. A collimated or 2D technology allows for visibility and measurement in such a distance. With the use of such measurement devices, illumination in the heated volume may not be needed.

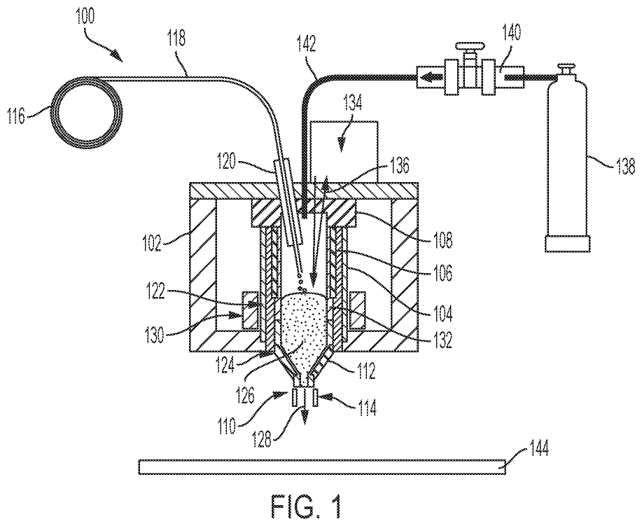

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block or an enclosure. The ejector 104 can be defined as an inner volume 132 (also referred to as an internal cavity or an inner cavity). The ejector 104 can be defined as a structure that can be selectively activated in such a manner as to cause a build material, print material to be ejected from a nozzle 110 of the ejector. The nozzle 110 can be defined as a physical structure of the ejector from which a build material or print material takes flight. A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber of the ejector 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air shield 114 or argon shield located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, that is positioned proximate to (e.g., below) the nozzle 110. The substrate 144 may include a heating element, or alternatively be constructed of brass or other materials. In certain examples, the substrate 144 may further include a build plate made of brass which can be coated with nickel to promote the wetting of molten aluminum droplets when they impinge on the build plate. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Z direction. In case of a nozzle 110 moving, the nozzle 110 and other printhead assembly components can include a nozzle or printhead motor control, not shown herein.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein may alternatively include other printing materials such as plastics or other ductile materials that are non-metals. The print material may include a metal, a metallic alloy, or a combination thereof. A non-limiting example of a printing material may include aluminum. Exemplary examples of printing systems of the present disclosure may include an ejector for jetting a print material, including a structure defining an inner cavity, and a nozzle orifice in connection with the inner cavity and configured to eject one or more droplets of liquid print material, wherein the ejector is configured to print a first layer of a three-dimensional printed part from a standoff position relative to the substrate 144 and the ejector is configured to print one or more remaining layers onto the first layer from a z-height position relative to a top surface of the first layer.

Printing systems 100 as shown in FIG. 1 can further include a 2-dimensional beam sensor, wherein a beam emitted by the 2-dimensional beam sensor measures a drop of the liquid printing material when the drop is between the ejector 104 and the substrate 144 or when the drop is between the ejector 104 and a surface of a part being printed by the printing system 100. An inner chamber can be located below the ejector 104 and above the substrate 144, and an outer chamber area which includes an emitter and a detector of a 2-dimensional beam sensor. Laser systems of the present disclosure can characterize rods, shafts, drops or other shapes. The hardware for characterization can be isolated outside of the build volume, which is typically a high temperature environment, with only the laser or measurement beam passing through the build volume internal space. The outer chamber area can include at least one aperture through which the beam passes to measure one or more drops of printing material while in flight. The aperture can include a door configured to intermittently cover the at least one or more aperture. In certain examples, measurement could be intermittent if the aperture is opened to measure, in order to minimize heat loss from opening an aperture external to the build volume or encasement surrounding the build volume. Erroneous or non-standard measurements can trigger a user interface (UI) or other means to signal to an operator, providing feedback and instructions to perform an intervention. The UI may proactively pause one or more operations in the printer to refrain from continuing to build a part with erroneous or non-standard printing or ejection conditions.

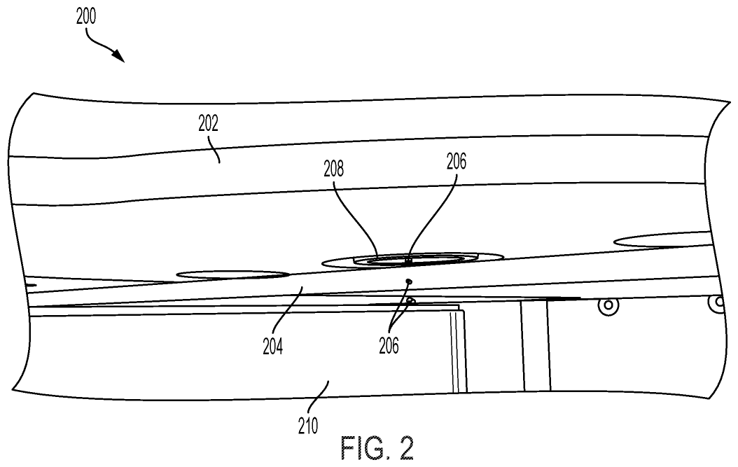

FIG. 2 depicts an enlarged side view of a bottom portion of an ejector nozzle of a 3D printer, in accordance with the present disclosure. A portion of a 3D printer system having an in-flight characterization system 200 is shown, having a bottom plate 202 attached to the printhead. Below the bottom plate 202 of the printhead is a measurement beam 204, which in this case is a collimated laser beam, traversing a region below the bottom plate 202 between the nozzle 208, where one or more drops 206, a physical structure from which build material begins flight, or from which print material is ejected from, and a build part 210 or 3D printed object. In certain examples, the drops 206 can land directly onto a substrate or build plate as an alternative to landing on a top surface of a build part 210 or 3D printed object. A collimated beam of light or other electromagnetic radiation includes parallel rays, and therefore will spread minimally, i.e., will not disperse with distance traveled, as it propagates from an emitter to a detector or until it is intersected by a drop of print material or other object. A perfectly collimated light beam, with no divergence, would not disperse with distance. A laser beam, such as the one shown and described herein, can be advantageous in comparison with alternate methods of drop measurement or characterization, such as reduced costs, number of components, less dependence on lighting, special lenses, or lens placement. Certain examples of laser measurement systems applicable for use within 3D print systems of the present disclosure can read at up to 16 kHz, which can be equivalent to 400 drops in a 1 second sample if, for example, the drops are being fired at 400 Hz. The sample size and timing can change based on drop frequency which can vary from 50 Hz to 1000 Hz depending on the printer settings and functionality being exercised on the printer. An example collimated laser measurement system can be based on a LED or 2D Laser collimated inspection system similar to an LS-9000 system, available from Keyence, which can provide real time accuracy for drops in flight of 2 μm and repeatability of 0.1 μm at 16 kHz. The drop sizes may range from about 400 μm to about 500 μm, with ˜0.5 mm being a targeted drop size. Drop velocity can range from about 4 m/s to about 10 m/s, or from about 1 m/s to about 15 m/s or from about 4 m/s to about 20 m/s.

The system can include a 2-dimensional beam sensor that measures the drop across the flight trajectory between the nozzle and the build part. As the drop transits through the beam it is detected, and its size and shape are measured. If any of the drop parameters fall outside of the set parameters, for example, diameter <500 μm, a signal is sent via an electrical connection to alert the system that it is not working at optimal levels. At this point, the system is paused to allow the operator to evaluate the system. If, for example, build up around the nozzle is noticed, the nozzle can be cleaned or replaced, and the build process is started again with the sensing restarting to continuously monitor the drops. The system continuously measures each drop or optionally can be used to statistically sample drops within the build. The measurement subsystem, monitoring subsystem, and other subsystems can be integrated an in communication with the use of one or more microprocessors or computer systems.

The 3D printer system includes a heated enclosed and insulated box around the build volume to maintain higher build temperatures within the build volume. This is shown in the forthcoming figures and is shown as a transparent enclosure, although such an enclosure need not be limited to a transparent or translucent material. The sensing systems can reside outside of this build volume. The emitter and collector portion of the sensing system transit the outer insulated area via a transparent wall, 2-dimensional slit or aperture, or a combination thereof. This aperture may include an activated cover for intermittent measurement and transmission of the measurement through the build volume or an optional air curtain or other means of temperature insulation. Additional illustrative materials for an enclosure may include, but are not limited to quartz, glass, steel, ceramic with additional insulation, or combinations thereof. It should be noted that the enclosure can be configured and constructed in such a manner with any combination of the aforementioned materials to prevent light from escaping from the enclosure. While not being bound by any particular theory, in certain examples, such a light-tight enclosure can further support accurate measurements by the system and methods described herein.

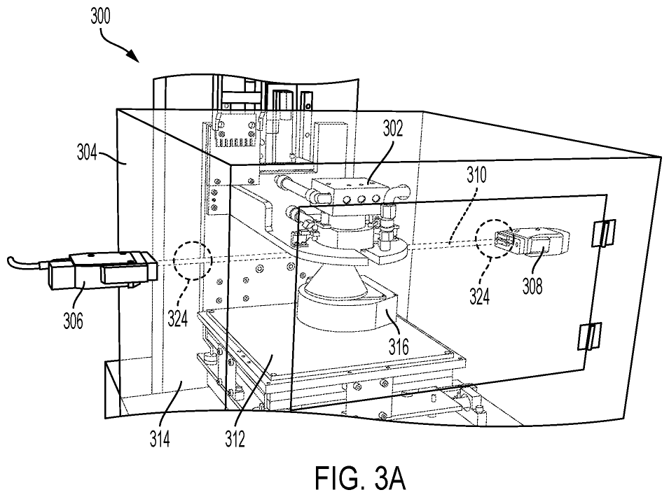

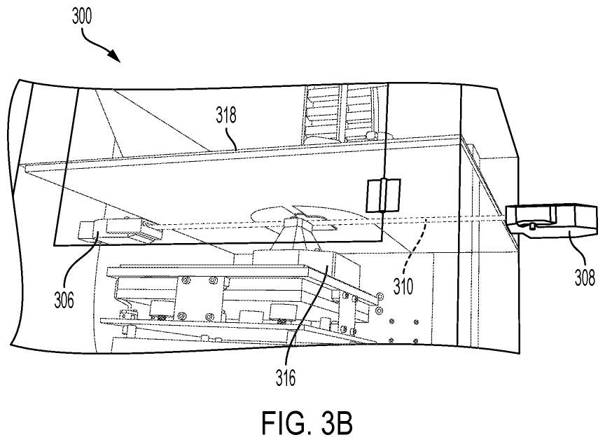

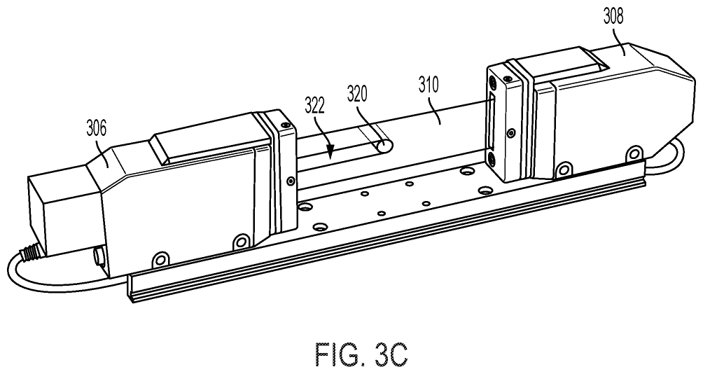

FIGS. 3A-3C depict several views of a 3D printer system having an in-flight characterization system, in accordance with the present disclosure. FIG. 3A shows a 3D printer system having an in-flight characterization system 300 is shown having a printhead 302 enclosed within a housing 304. External to the housing 304 is an emitter 306 of an in-flight characterization system, with a detector 308 of the in-flight characterization system positioned on an opposite side of the housing 304, positioned such that a measurement beam 310 transmits through an internal volume of the housing 304 and transmits through a space through which a drop 320 of build material or print material will travel when ejected from the printhead 302, and onto a substrate 312 or a build part or 3D printed object 316. One or more side walls or external walls 314 of the housing 304 may include an aperture 324 or window in an external wall 314 of the housing 304 to intermittently allow the measurement beam 310 to transmit through the external housing 304. In certain examples, the measurement beam 310 is employed continuously, while in others, it can be employed intermittently in one or more intervals determined to best evaluate system performance during the building of an object 316.

FIG. 3B is an enlarged view of a portion of the 3D printer system having an in-flight characterization system of FIG. 3A, showing a top thermal shield 318 and a build part or 3D printed object 316 being formed. An alternate perspective view of the characterization system with the emitter 306 of the in-flight characterization system, with a detector 308 of the in-flight characterization system positioned on an opposite side of the housing 304, positioned such that a measurement beam 310 transmits between the 3D printed object 316 being formed and the nozzle, not shown in this view. FIG. 3C is a perspective view of an exemplary in-flight characterization system where the emitter 306 of the in-flight characterization system and the detector 308 of the in-flight characterization system are positioned in such a manner that a measured drop 320 of build material or print material intersects or disrupts the measurement beam 310, creating a gap 322 in the measurement beam 310.

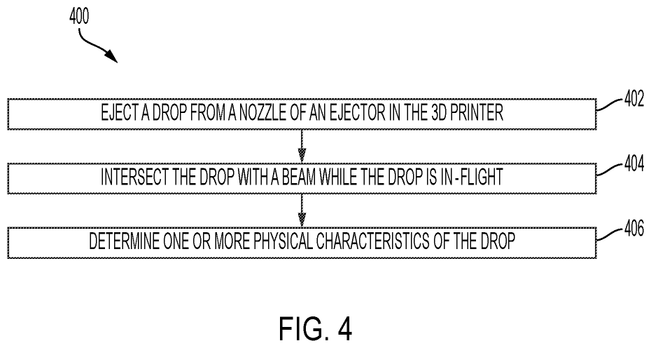

FIG. 4 is a flowchart illustrating a method of characterizing drops of printing material in a 3D printer, in accordance with the present disclosure. A method of characterizing drops of printing material in a 3D printer 400 includes the ejection of a drop from a nozzle of an ejector in the 3D printer 402, intersecting the drop with a beam while the drop is in-flight 404, and determining one or more physical characteristics of the drop 406. The method of characterizing drops of printing material in a 3D printer 400 may include where the drop intersects the beam between the nozzle and a substrate of the 3D printer, or in certain examples, where the drop intersects the beam between the nozzle and a top surface of a part printed by the 3D printer. The beam can be in a horizontal orientation and can be located between an emitter and a detector are each positioned external to one or more side walls of a 3D printer. The method of characterizing drops of printing material in a 3D printer 400 in certain examples, includes where a physical characteristic of the drop includes drop size, drop shape, or drop mass or a combination thereof. In certain examples one of these preceding physical characteristics of the drop is compared with a reference. This comparison can further include determining a defect associated with a measured drop. As a result of the measurements or comparisons, one or more printing operations can be paused, and in some instances a defect in a drop ejected by the 3D printer may be corrected or adjusted, potentially by adjusting one or more parameters of the 3D printer operation. The print material used in such a printer operation or in a method of characterizing drops of printing material in a 3D printer 400 can include aluminum, an alloy, or other print materials or build materials as described herein.

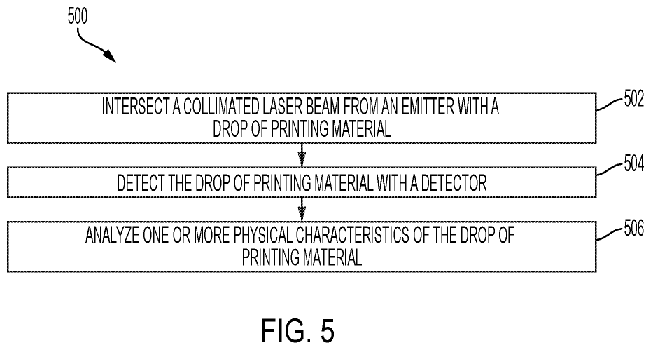

FIG. 5 is a flowchart illustrating a method of characterizing drops of printing material in a 3D printer, in accordance with the present disclosure. A method of characterizing drops of printing material in a 3D printer 500 includes intersecting a collimated laser beam from an emitter with a drop of printing material 502, detecting the drop of printing material with a detector 504, and analyzing one or more physical characteristics of the drop of printing material 506. The method of characterizing drops of printing material in a 3D printer 500 may include analyzing physical characteristics of the drop including drop size, drop shape, drop mass, or a combination thereof. In certain examples one of these preceding physical characteristics of the drop is compared with a reference. This comparison can further include determining a defect associated with a measured drop. The one or more drops of printing material intersects the collimated laser beam while the drop is in-flight. The system and method of the present disclosure provides a manner of scanning a drop as it passes through the beam. It will be scanned with a high sampling rate that allows the system to analyze, display and categorize the topography of the drop as it moves through the beam. That topography is then translated to a 2D shape, for example, a circle of a set diameter. If the shape falls outside of a chosen parameter, it could indicate a system issue. In one example, if the diameter shows itself to be either greater or smaller than acceptable, the system can send a fault code to indicate to an operator there could be an issue with the system. Additionally, the system can monitor the drops and create a statistical model based on the distribution of the size, shape, or other parameter of the measured drops. As this system uses an emitter/collector setup, the components work by determining the amount of beam that arrives at the collector. By evaluating the amount of light received or not received, the system determines the size of the slice of object blocking the beam. The beam can, in certain examples, be transmitted through a glass panel or other transmissive material, provided the beam is not distorted by reflection, refraction, or contaminants on the transmissive material. An alternate manner of avoiding this issue is the use of an aperture, shutter, door, window or air curtain. In certain examples, a “light tight” enclosure for one or more components of the disclosed printing system or measurement system may be employed.

Advantages of the system and methods for drop characterization of the present disclosure include a system that measures in-flight molten metal drop characteristics, such as, but not limited to, shape and size in a magnetohydrodynamics (MHD) printer. Such a system can compare metal drop characteristics measured in flight during printing to known parameters to evaluate print process quality during a part build. The characterization system provides real time analysis of drop quality to identify issues with the jetting or nozzle condition, which can occur due to sputtering and/or dross buildup at the nozzle exit. This provides the capability to evaluate drop quality and correlate the measured drop characteristics to build quality issues before part completion, allowing the system to be paused or shutdown to eliminate wasted print time and issues with the final part build. The system further provides a capability to infer drop mass based on drop measurement. This real time monitoring can ensure the system is performing to specifications that will lead to a good quality part and reduce the probability of a fully printed part having defects caused by printed drop quality issue. This ability to monitor and adjust print system during build by inspecting drop quality and pausing the system prior to completion of the build part allows an operator to inspect the part and either save the part by pausing the build to correct the issue or save the remaining build time in the case of a failed part.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including.” “includes,” “having.” “has,” “with.” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of characterizing drops of printing material in a 3D printer, comprising:
ejecting a drop from a nozzle of an ejector in the 3D printer;
intersecting the drop with a beam while the drop is in-flight; and
determining one or more physical characteristics of the drop.

2. The method of characterizing drops of printing material in a 3D printer of claim 1, wherein the drop intersects the beam between the nozzle and a substrate of the 3D printer.

3. The method of characterizing drops of printing material in a 3D printer of claim 1, wherein the drop intersects the beam between the nozzle and a top surface of a part printed by the 3D printer.

4. The method of characterizing drops of printing material in a 3D printer of claim 1, wherein the beam is in a horizontal orientation.

5. The method of characterizing drops of printing material in a 3D printer of claim 1, wherein the beam is located between an emitter and a detector are each positioned external to one or more side walls of a 3D printer.

6. The method of characterizing drops of printing material in a 3D printer of claim 1, wherein a physical characteristic of the drop comprises drop size.

7. The method of characterizing drops of printing material in a 3D printer of claim 1, wherein a physical characteristic of the drop comprises drop shape.

8. The method of characterizing drops of printing material in a 3D printer of claim 1, wherein a physical characteristic of the drop comprises drop mass.

9. The method of characterizing drops of printing material in a 3D printer of claim 1, further comprising comparing the one or more physical characteristics of the drop with a reference.

10. The method of characterizing drops of printing material in a 3D printer of claim 9, further comprising determining a defect by comparing one or more physical characteristics of the drop with a reference.

11. The method of characterizing drops of printing material in a 3D printer of claim 1, further comprising pausing one or more printing operations.

12. The method of characterizing drops of printing material in a 3D printer of claim 1, further comprising correcting a defect in a drop ejected by the 3D printer.

13. The method of characterizing drops of printing material in a 3D printer of claim 1, wherein the print material comprises aluminum.

14. A method of characterizing drops of printing material in a 3D printer, comprising:
intersecting a collimated laser beam from an emitter with a drop of printing material;
detecting the drop of printing material with a detector; and
analyzing one or more physical characteristics of the drop of printing material.

15. The method of characterizing drops of printing material in a 3D printer of claim 14, wherein a physical characteristic of the drop comprises drop size, drop shape, drop mass, or a combination thereof.

16. The method of characterizing drops of printing material in a 3D printer of claim 14, wherein the drop of printing material intersects the collimated laser beam while the drop is in-flight.

17. The method of characterizing drops of printing material in a 3D printer of claim 14, further comprising comparing the one or more physical characteristics of the drop with a reference.

18. The method of characterizing drops of printing material in a 3D printer of claim 14, further comprising determining a defect by comparing one or more physical characteristics of the drop with a reference.

19. A printing system, comprising:
a substrate;
an ejector for jetting a liquid print material onto the substrate; and
a 2-dimensional beam sensor, wherein a beam emitted by the 2-dimensional beam sensor measures a drop of the liquid printing material when the drop is between the ejector and the substrate.

20. The printing system of claim 19, wherein the beam emitted by the 2-dimensional beam sensor measures the drop of the liquid printing material when the drop is between the ejector and a surface of a part being printed by the printing system.

21. The printing system of claim 19, wherein the liquid print material comprises a metal, a metallic alloy, or a combination thereof.

22. The printing system of claim 21, wherein the liquid print material comprises aluminum.

23. The printing system of claim 19, wherein the ejector further comprises:
a structure defining an inner cavity; and
a nozzle orifice in connection with the inner cavity and configured to eject one or more drops of liquid print material.

24. The printing system of claim 19, further comprising:
an inner chamber located below the ejector and above the substrate; and
an outer chamber area comprising an emitter and a detector of the 2-dimensional beam sensor.

25. The printing system of claim 19, further comprising at least one aperture through which the beam passes.

26. The printing system of claim 25, further comprising a door configured to intermittently cover the at least one or more aperture.

27. The printing system of claim 24, wherein the inner chamber permits no light to enter or escape.
